(19) United States
(12) Patent Application Publication
(10) Pub. No.: US 2019/0110130 A1
(43) Pub. Date: Apr. 11, 2019

(54) AUDIO DEVICE AND AUDIO SYSTEM HAVING AUDIO DEVICE ATTACHED THERETO

(71) Applicant: KYOCERA Corporation, Kyoto (JP)

(72) Inventor: Tomohiro INAGAKI, Yokohama-shi (JP)

(73) Assignee: KYOCERA Corporation, Kyoto (JP)

(21) Appl. No.: 16/149,277

(22) Filed: Oct. 2, 2018

(30) Foreign Application Priority Data
Oct. 6, 2017 (JP) 2017-196070

(51) Int. Cl. H04R 17/00

(52) U.S. Cl. CPC H04R 17/00; H04R 2499/11; H04R 2460/13

(57) ABSTRACT

An audio device and an audio system are provided. The audio device includes a panel, a vibration source attached to the panel, and a housing for supporting the panel. The housing is provided with an attaching portion.

### CROSS REFERENCE TO RELATED APPLICATION

This application claims priority to and the benefit of Japanese Patent Application No. 2017-196070 (filed on Oct. 6, 2017), the entire contents of which are incorporated herein by reference.

### TECHNICAL FIELD

The present disclosure relates to an audio device configured to transmit a sound on the basis of vibration by a vibrator.

### BACKGROUND

A known electronic device transmits an air conduction sound and a human body vibration sound to a user.

### SUMMARY

An audio device according to embodiments of the present disclosure includes a panel, a vibration source attached to the panel, and a housing for supporting the panel. The housing is provided with an attaching portion.

### BRIEF DESCRIPTION OF THE DRAWINGS

In the accompanying drawings:

FIG. 1 is a diagram illustrating the functional blocks of an electronic device according to an embodiment of the present disclosure.

FIG. 2 is a schematic diagram illustrating a relationship between a panel of the electronic device and an ear.

FIGS. 3A and 3B are diagrams illustrating an implementation structure of the electronic device.

FIG. 4 is a diagram illustrating an example of vibration of the panel of the electronic device.

FIG. 5 is a perspective view of an audio device.

FIG. 6 is a cross-sectional view of the audio device.

FIG. 7 is a diagram illustrating the audio device and the electronic device having the audio device attached thereto.

FIG. 8 is a schematic diagram illustrating an example of use in which a user uses the audio device and the electronic device having the audio device attached thereto.

FIG. 9 is a diagram illustrating flows of audio signals of the audio device and the electronic device.

FIG. 10 is a diagram illustrating flows of audio signals of the audio device and the electronic device.

### DETAILED DESCRIPTION

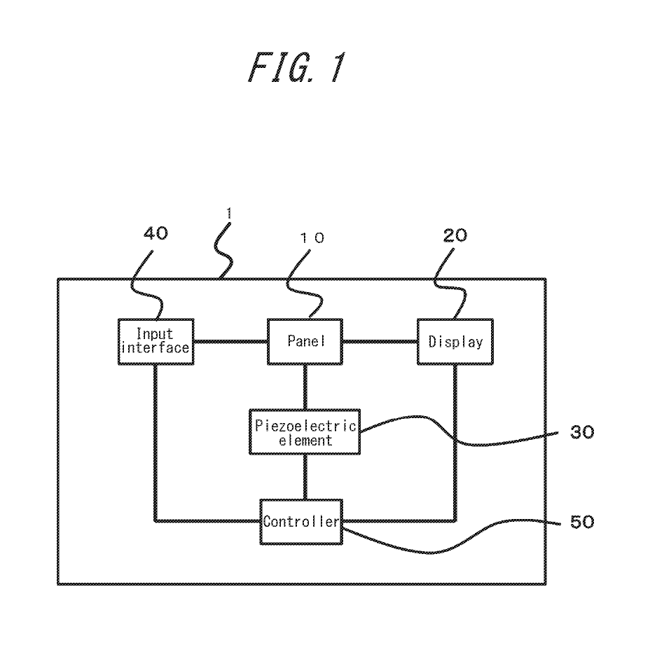

Hereinafter, an embodiment of the present disclosure will be described in detail with reference to the accompanying drawings. FIG. 1 is a diagram illustrating the functional blocks of an electronic device 1 according to the embodiment of the present disclosure. The electronic device 1 is, for example, a mobile phone (a smartphone) and includes a panel 10, a display 20, a piezoelectric element 30, an input interface 40, and a controller 50.

The panel 10 may be a touch panel for detecting a contact, or a cover panel for protecting the display 20. The panel 10 is made of, for example, glass or synthetic resin such as acrylic. Preferably, the panel 10 has a plate-like shape. When the panel 10 is a touch panel, the panel 10 detects a contact made by a users finger, a pen, or a stylus pen. The detection method employed by the touch panel may be any appropriate detection method such as a capacitive type, a resistive film type, a surface acoustic wave type (or an ultrasound type), an infrared type, an electromagnetic induction type, or a load detection type.

The display 20 is a display device such as a liquid crystal display, an organic electroluminescent display, or an inorganic electroluminescent display. The display 20 is provided on a rear side of the panel 10. The display 20 is attached to the rear side of the panel 10 via a joining member (e.g., an adhesive). The display 20 may be arranged being spaced apart from the panel 10 and supported by the housing of the electronic device 1.

The piezoelectric element 30 is an element which, upon receiving an electronic signal (i.e., a voltage), expands and contracts in accordance with an electromechanical coupling coefficient of a material thereof. The element is made of, for example, a ceramic or a crystal material. The piezoelectric element 30 may be a unimorph, a bimorph, or a laminated piezoelectric element. The laminated piezoelectric element includes a laminated bimorph element made up of laminated bimorphs (e.g., 16 or 24 layers thereof). The laminated piezoelectric element includes a plurality of dielectric layers made of, for example, PZT (lead zirconate titanate) and an electrode layer disposed between the dielectric layers.

The piezoelectric element 30 is arranged on the rear side of the panel 10. The piezoelectric element 30 is attached to the panel 10 via a joining member (e.g., double-sided tape). The piezoelectric element 30 may be attached to the panel 10 via an intermediate member (e.g., a metal plate).

The input interface 40 receives input operations from the user and includes, for example, an operation button (i.e., an operation key). When the panel 10 is a touch panel, the panel 10 may also receive input operations from the user by detecting contacts made by the user.

The controller 50 is a processor configured to control the electronic device 1 and applies a predetermined electric signal (a voltage corresponding to an audio signal) to the piezoelectric element 30. For example, the controller 50 may apply ±15 V signal, which is higher than a ±5 V signal of a so-called panel speaker applied for the purpose of transmitting a sound by means of air conduction sound rather than human body vibration sound. In this matter, when the user presses the panel 10 against the user's body by applying, for example, a force of 3N or more, the panel 10 vibrates sufficiently to generate a human body vibration sound through a part of the user's body. The voltage to be applied may be appropriately adjusted in consideration of fixing strength of the panel 10, performance of the piezoelectric element 30, etc. When the controller 50 applies an electric signal to the piezoelectric element 30, the piezoelectric element 30 expands and contracts in its longitudinal direction. At this time, the panel 10 having the piezoelectric element 30 attached thereto is deformed by the expansion and contraction of the piezoelectric element 30 and thus vibrates. Thus, the panel 10 generates air conduction sound and, when a part of the user's body (e.g., outer cartilage) contacts the panel 10, also generates human body vibration sound through the part of the user's body. For example, the controller 50 may apply an electric signal corresponding to an audio signal of another party's voice in a phone call or music such as a ring tone or a song to the piezoelectric element 30, and thus generate air conduction sound and human body vibration sound corresponding to the electric signal. The audio signal related to the electric signal may be based on music data stored in an internal memory or music data stored in an external server or the like to be played via a network.

The panel 10 vibrates in an attaching region thereof to which the piezoelectric element 30 is attached and also a region remote from the attaching region. At any particular instant, the panel 10 vibrates having portions with relatively large vibration amplitude and portions with relatively small vibration amplitude randomly distributed across the panel 10. That is, vibrations of a plurality of waves are detected across the panel 10. Thus, the user can listen to a sound by bringing a region remote from the attaching region of the panel 10 described above into contact with the ear.

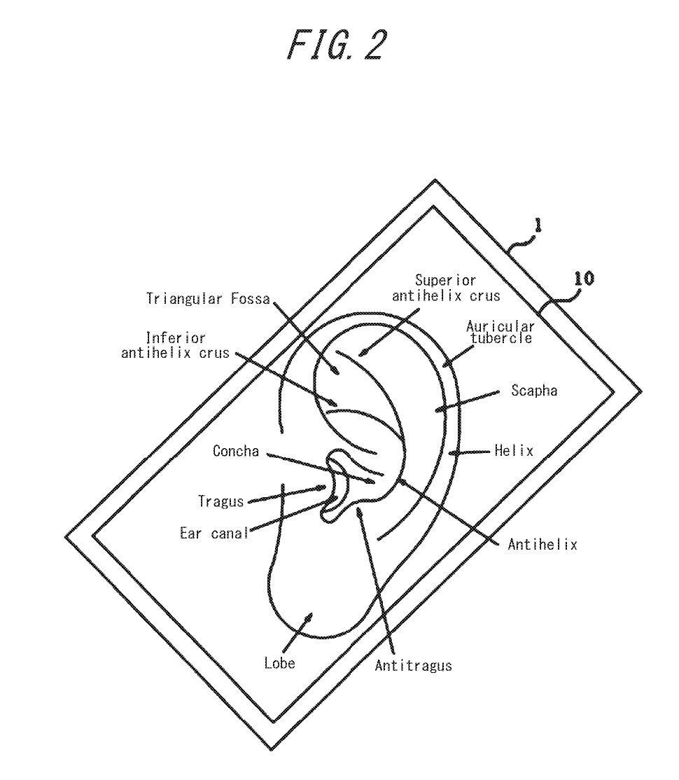

Here, as illustrated in FIG. 2, the size of the panel 10 may be substantially the same as or greater than the user's ear. In this case, when the user listens to the sound, the user's entire ear is likely to be covered by the panel 10 of the electronic device 1, and thus ambient sound (i.e., noise) entering the external auditory canal is reduced. The panel 10 may be vibrated in a region wider than a region with a length corresponding to a distance between the helix and the tragus or the antitragus and a width corresponding to a distance between the crus of helix and the antihelix. The average ear size of a Japanese person can be obtained by referring to Japanese Human Body Size database (1992-1994) created by the Research Institute of Human Engineering for Quality Life (HQL). When the panel 10 is larger than the average ear size of a Japanese person, the panel 10 may be considered as being large enough to cover the ears of most people from other countries.

The electronic device 1 described above is capable of transmitting air conduction sound and human body vibration sound, which is generated through a part (e.g., the cartilage of the external ear) of the user's body to the user. Thus, less sound is transmitted to the surroundings of the electronic device 1 due to vibration of air as compared to sound from dynamic speakers. Accordingly, these sounds may be favorably used, for example, for replay of a recorded voice on a train or the like.

The electronic device 1 described above transmits the human body vibration sound by vibrating the panel 10. Thus, even when the user is wearing, for example, earphones or headphones, the user may hear the sounds via the earphones or headphones and a part of the user's body by bringing the electronic device 1 into contact with the earphones or headphones.

The electronic device 1 described above transmits a sound to the user by vibrating the panel 10. Thus, when the electronic device 1 does not include a separate dynamic speaker, there is no need to form an opening (i.e., a sound emitting port) for sound transmission in the housing, enabling a simple waterproof structure for the electronic device 1. When the electronic device 1 includes a dynamic speaker, the sound emitting port may be closed by a member which passes gas but does not pass liquid. Materials which pass gas but do not pass liquids include, for example, Gore-Tex® (Gore-Tex is a registered trademark in Japan, other countries, or both).

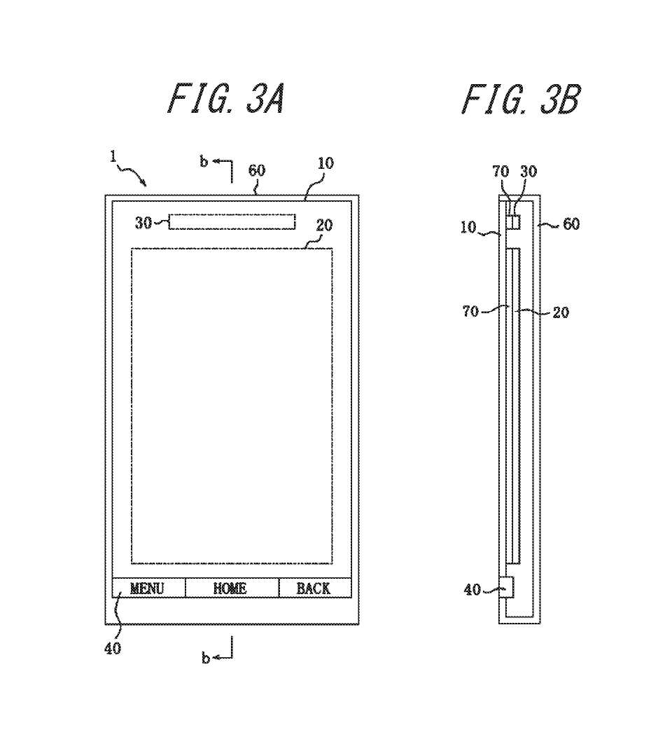

FIGS. 3A and 3B are diagrams illustrating an implementation structure of the electronic device 1 according to a first embodiment. FIG. 3A is an elevation view, and FIG. 3B is a cross-sectional view taken from line b-b of FIG. 3A. The electronic device 1 illustrated in FIGS. 3A and 3B is a smartphone in which the panel 10 formed with a glass plate and serving as a touch panel is arranged on a front side of a housing 60 (e.g., a metal or resin casing). The panel 10 and the input interface 40 are supported by the housing 60. The display 20 and the piezoelectric element 30 are each attached to the panel 10 via a joining member 70. The joining member is an adhesive having a thermosetting or ultraviolet curing property, or double-sided tape. Alternatively, the joining member 70 may be, for example, an optical elastic resin such as a colorless acrylic ultraviolet curing adhesive. Each of the panel 10, the display 20, and the piezoelectric element 30 are substantially rectangular in shape.

The display 20 is arranged substantially in the center of a transverse direction of the panel 10. The piezoelectric element 30 is arranged being spaced apart from a longitudinal end portion of the panel 10 by a predetermined distance in such a manner that a longitudinal direction of the piezoelectric element 30 extends along the transverse side of the panel 10. The display 20 and the piezoelectric element 30 are arranged side by side in a direction parallel to an internal surface of the panel 10.

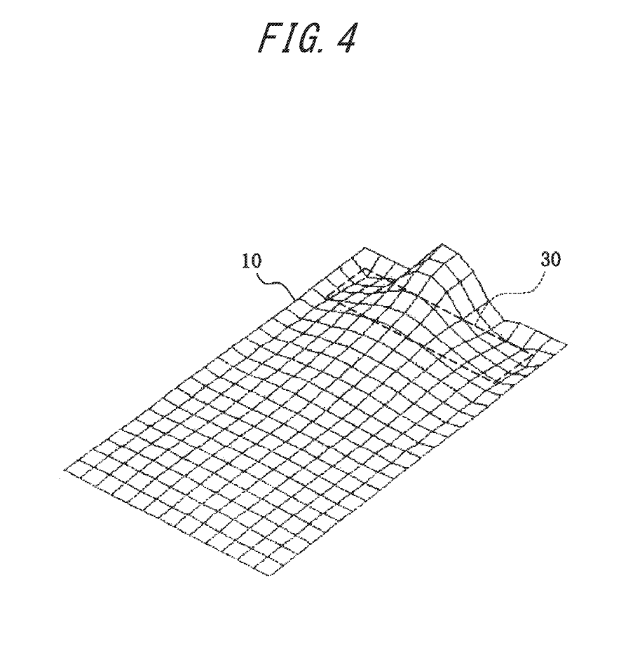

FIG. 4 is a diagram illustrating an example of vibration of the panel 10 of the electronic device 1 according to the first embodiment. In the electronic device 1 according to the first embodiment, the display 20 is attached to the panel 10. This enhances rigidity of a lower portion of the panel 10 and increases vibration of an upper portion of the panel 10 having the piezoelectric element 30 attached thereto such that it is greater than the vibration of the lower portion of the panel 10. Thus, sound leakage from the lower portion of the panel 10 due to vibration thereof may be suppressed.

According to the electronic device 1 of the present embodiment, as described above, the panel 10 is deformed due to deformation of the piezoelectric element 30 attached to the rear side of the panel 10, and thus sound vibration is transmitted to a target in contact with the panel 10 being deformed. Thus, air conduction sound and human body vibration sound may be transmitted to the user without needing to expose a vibration body from an exterior of the housing 60. Also, the user does not need to bring the piezoelectric element 30 into direct contact with the user's ear. Thus, the piezoelectric element 30 is less likely to be damaged. In cases where the housing of a terminal is deformed rather than the panel, the user may drop the terminal due to the vibration. However, when the panel 10 is vibrated, this is unlikely to occur.

The piezoelectric element 30 is attached to the panel 10 via the joining member 70. Thus, it is possible to attach the piezoelectric element 30 to the panel 10 in a manner which does not substantively inhibit the degree of freedom of deformation of piezoelectric element 30. The joining member 70 may be a non-thermosetting adhesive. Thereby thermal stress contraction may be less likely to occur between the piezoelectric element 30 and the panel 10 when the joining member 70 sets. Alternatively, the joining member 70 may be double-sided tape. Thereby, unlike an adhesive, a contraction stress may be less likely to occur between the piezoelectric element 30 and the panel 10.

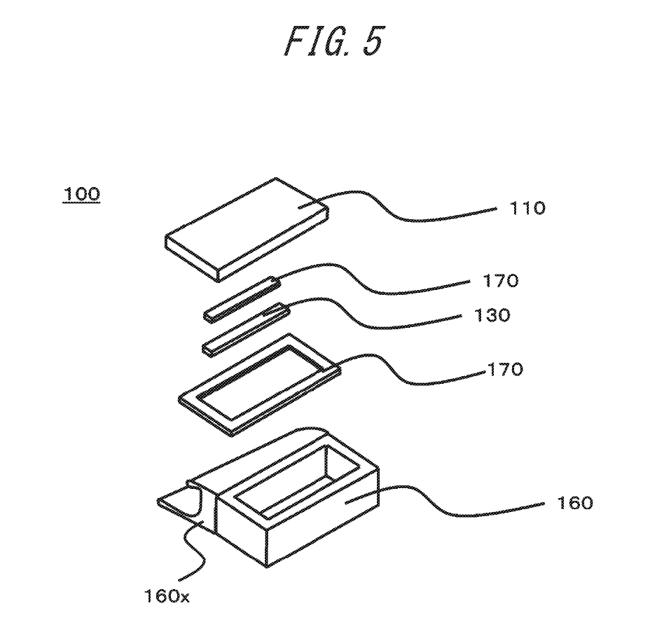

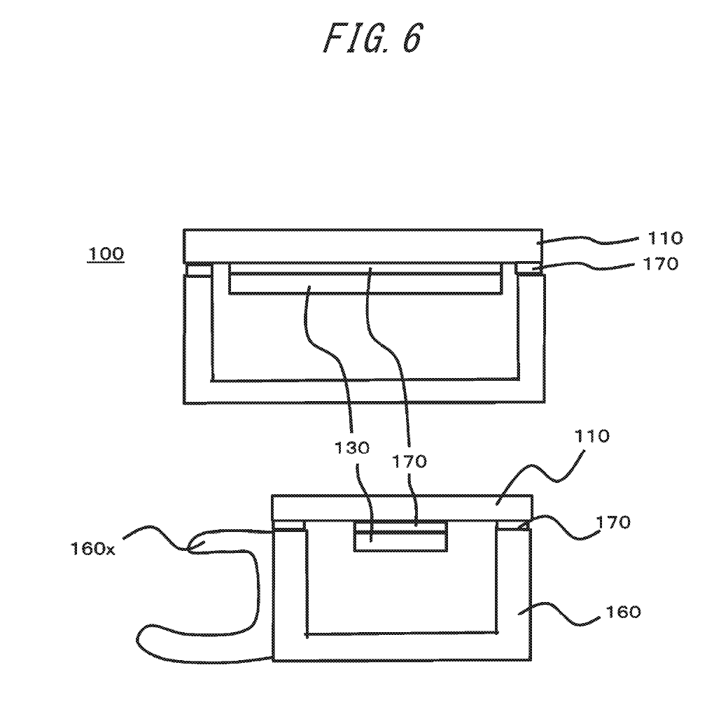

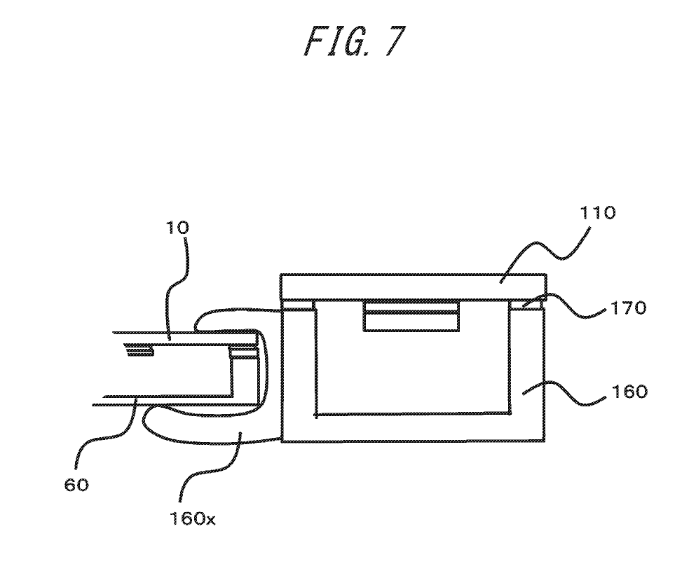

Next, an example of an audio device will be described with reference to FIG. 5. An audio device 100 includes a panel 110 to be brought into contact with a human body, a piezoelectric element 130 serving as a vibration source for vibrating the panel 110, a joining member 170 that joins the panel 110 and the piezoelectric element 130 together, a housing 160, and a joining member 170 that joins the panel 110 and the housing 160 together.

The housing 160 includes an attaching portion 160x to be attached to the electric device 1.

The panel 110 may be made of, for example, a material such as glass, acrylic, aluminum, and stainless steel. Alternatively, the panel 110 may be formed as a composite of these materials. The panel 10 has a plate shape. The panel 110 is, for example, 1 cm to 4 cm in length and 0.5 cm to 2 cm in width.

The piezoelectric element 130 is an element which, upon receiving an electronic signal (a voltage), expands and contracts in accordance with an electromechanical coupling coefficient of a material thereof. The element is made of, for example, a ceramic or a crystal material. The piezoelectric element 130 may be a unimorph, a bimorph, or a laminated piezoelectric element. The laminated piezoelectric element includes a laminated bimorph element made up of laminated bimorphs (e.g., 16 or 24 layers thereof). The laminated piezoelectric element includes a plurality of dielectric layers made of, for example, PZT (lead zirconate titanate) and an electrode layer disposed between the dielectric layers. The piezoelectric element 130 is attached to the rear side of the panel 110 via the joining member 170. Other than the piezoelectric element, a magnetostrictive element, a dynamic vibrator and the like may also function as a vibration source.

The housing 160 is made from a resin. The housing 160 may be made from a ceramic, a metal, a composite material thereof, glass, or the like. The panel 11 is attached to the housing 160 via the joining member 170.

The housing 160 includes the attaching portion 160x. The attaching portion 160 may be integrally molded with another portion of the housing 160. In order to form the housing 160 illustrated in FIG. 5 integrally with the attaching portion 160x, two molds with different extraction directions may be used. Alternatively, they may be integrally formed by a 3D printer. A portion other than the attaching portion 160x, e.g., a box-like portion for holding the panel 110 may be formed separately from the attaching portion 160x and joined to the attaching portion 160x by a joining member or the like.

The attaching portion 160x clips to an electronic device such as a smartphone. In this way, the audio device 100 is attached to the electronic device 1.

The audio device 100 may receive an audio signal from an electronic device equipped with a sound source or from another device via Wi-Fi or Bluetooth® (Bluetooth is a registered trademark in Japan, other countries, or both). When the electronic device is a smartphone or similar, the audio device 100 may transmit and receive an audio signal and the like from a USB port or a 3.5 mm diameter earphone jack via a signal line. Alternatively, the audio device itself may include a memory serving as a sound source.

The audio device 100 may include a power source such as a battery within the housing 160. Alternatively, the audio device 100 may receive power from a power source of the electronic device via the USB port or the 3.5 mm diameter earphone jack described above.

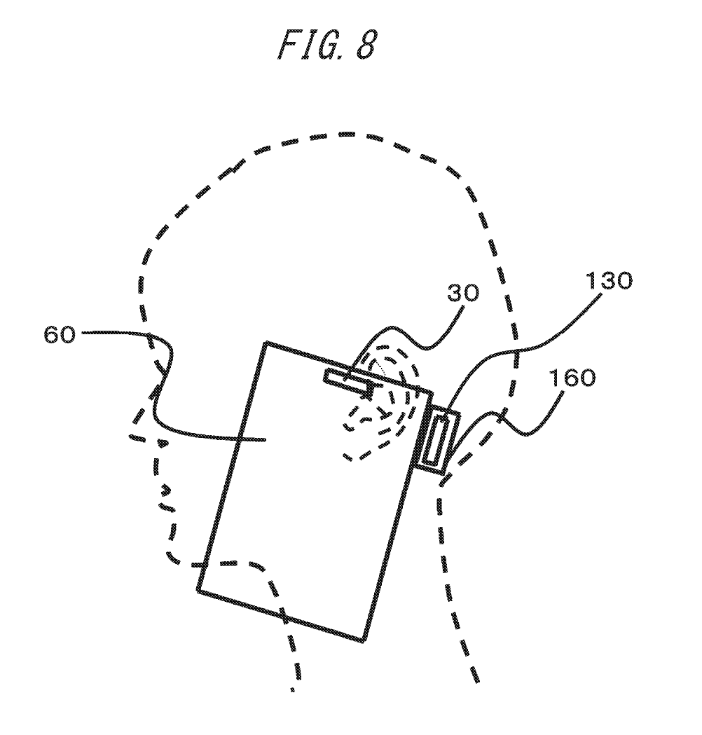

As illustrated in FIG. 8, when the user brings the panel 10 of the electronic device into contact with the tragus or in the vicinity thereof of the user's ear, the user may hear air conduction sound and human body vibration sound from the panel 10 and, simultaneously, bone conduction sound from the audio device 100. In the example illustrated in FIG. 8, the audio device 100 vibrates in the vicinity of the mastoid part of the temporal bone behind the ear.

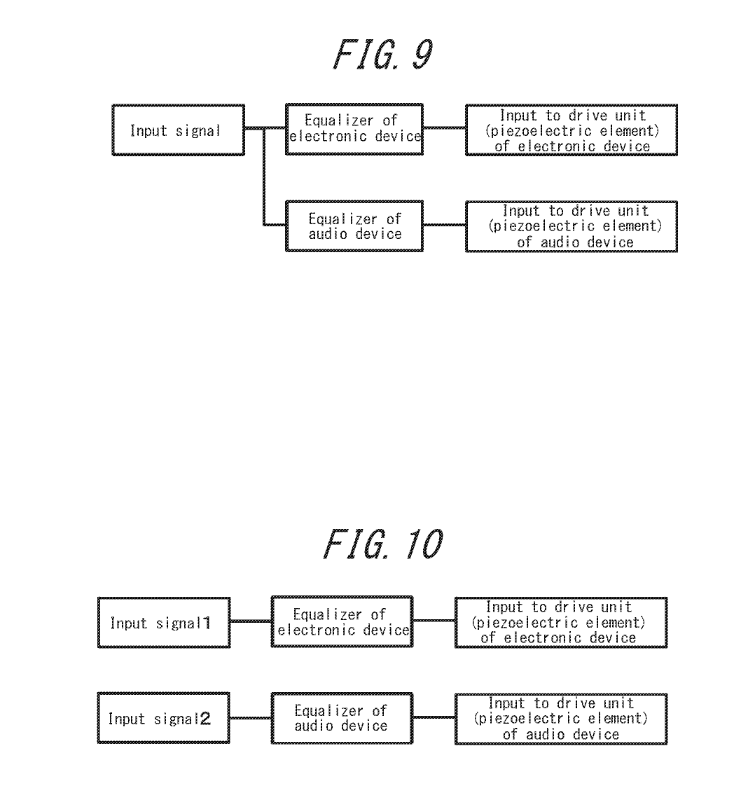

As illustrated in FIG. 9, the same sound signal may be input to the electronic device and the audio device, and the user may hear the same sounds or different sounds therefrom. Alternatively, sound signals based on the respective sound sources may be separately input, and the user may simultaneously hear different sounds.

The power of the input signal input to the piezoelectric element of the electronic device and the power of the input signal input to the piezoelectric element of the audio device can be differentiated from each other such that the user receives different sound pressures (the sound pressure of the combination of the air conduction sound and the human body vibration sound, and the sound pressure of the bone conduction sound). In particular, the powers of these inputs may be differentiated from each other such that the sound pressure of the combination of the air conduction sound and the human body vibration sound and the sound pressure of the bone conduction sound are different from each other.

Also, input signals from the same sound source may be input to the piezoelectric element of the electronic device and the piezoelectric element of the audio device at different timings. In particular, the input signals may be input in such a manner as to generate a phase between drive of the piezoelectric element of the electronic device and drive of the piezoelectric element of the audio device. This enables variations of sound image localization to make the user feel as if vibrations are presented to both the left and right sides of the user's body when vibrations are presented to only one side of the user's body. Also, a pseudo stereo effect may be generated.

A drive circuit for the electronic device 1 may be mounted on a substrate in the housing 60, and a drive circuit for the audio device 100 may be mounted on a substrate in the housing 160. Class H analog amplifiers or full digital amplifiers may be used as amplifiers in the drive circuits. In cases where a D-Amp driver for a full digital amplifier is used, the electric current can be reduced from 300 mA to 70 mA, as compared to a class H analog amplifier. Also, the sound pressure may be increased from approximately 10 dB (SPL) to 20 dB for low tones of 1 kHz or less.

Although this disclosure is based on embodiments and drawings, it is to be noted that various changes and modifications will be apparent to those skilled in the art based on this disclosure. Therefore, such changes and modifications are to be understood as included within the scope of this disclosure. For example, the functions and the like included in the various units and members may be reordered in any logically consistent way. Furthermore, units and members may be combined into one or divided.

1. An audio device comprising:
a panel, a vibration source attached to the panel, and a housing for supporting the panel,
wherein the housing is provided with an attaching portion.

2. The audio device according to claim 1,
wherein the audio device is configured to generate a bone conduction sound.

3. An audio system comprising:
the audio device according to claim 1; and
an electronic device for transmitting an audio signal to the audio device.

4. The audio system according to claim 3, wherein the audio system is configured to generate a bone conduction sound, an air conduction sound, and a human body vibration sound.
